(19) United States
(12) Patent Application Publication
(10) Pub. No.: US 2005/0210068 A1
(43) Pub. Date: Sep. 22, 2005

(54) Title examination systems and methods

(75) Inventors: Curt D. Szymanski, Waunakee, WI (US); Robert F. Anastasi, Louisville, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Zenodata Corporation, Louisville, CO (US)

(21) Appl. No.: 10/966,154

(22) Filed: Oct. 14, 2004

Related U.S. Application Data
(63) Continuation-in-part of application No. 10/804,472, filed on Mar. 18, 2004.
(63) Continuation-in-part of application No. 10/804,467, filed on Mar. 18, 2004.

(51) Int. Cl. G06F 7/00

(52) U.S. Cl. 707/104.1

(57) ABSTRACT

A title examination method includes receiving a request to examine title to a specific parcel. The request includes at least an identifier of the parcel. The method also includes extracting data from documents related to the parcel, assembling output by applying rules to the data extracted from the documents, and exporting the output to an external computer.

### CROSS-REFERENCES TO RELATED APPLICATIONS

This application is a continuation-in-part of and claims the benefit of co-pending, commonly-assigned U.S. patent application Ser. No. 10/804,472, entitled “AUTOMATED RECORD SEARCHING AND OUTPUT GENERATION RELATED THERETO” (Attorney Docket No. 040143-000200), filed on Mar. 18, 2004, and of co-pending, commonly-assigned U.S. patent application Ser. No. 10/804,467, entitled “DOCUMENT ORGANIZATION AND FORMATTING FOR DISPLAY” (Attorney Docket No. 040143-000400), filed on Mar. 18, 2004, the entirety of each of which are herein incorporated by reference for all purposes.

This applications is related to the following co-pending, commonly-assigned U.S. patent applications, the entirety of each of which are herein incorporated by reference for all purposes: Provisional U.S. Patent Application No. 60/554,511, entitled “PROPERTY RECORDS DATABASES AND SYSTEMS AND METHODS FOR BUILDING AND MAINTAINING THEM” (Attorney Docket No. 040143-000100), filed on Mar. 18, 2004; U.S. patent application Ser. No. 10/804,468, entitled “DOCUMENT SEARCH METHODS AND SYSTEMS” (Attorney Docket No. 040143-000300), filed on Mar. 18, 2004; Provisional U.S. Patent Application No. 60/554,514, entitled “CONFIDENCE-BASED NATURAL LANGUAGE PARSING” (Attorney Docket No. 040143-000500), filed on Mar. 18, 2004; Provisional U.S. Patent Application No. 60/554,513, entitled “CONTEXTUAL CONVERSION OF LANGUAGE TO DATA” (Attorney Docket No. 040143-000600) filed on Mar. 18, 2004; U.S. patent application Ser. No. 10/876,250, entitled “EVALUATING THE RELEVANCE OF DOCUMENTS AND SYSTEMS AND METHODS THEREFOR” (Attorney Docket No. 040143-000700), filed on Jun. 23, 2004; and U.S. patent application Ser. No. --/---,---, entitled “TITLE QUALITY SCORING SYSTEMS AND METHODS” (Attorney Docket No. 040143-000800), filed on ______.

### BACKGROUND OF THE INVENTION

The present invention relates generally to property record search and evaluation. More specifically, the present invention relates to systems and methods for examining property records to assess title quality.

The practice of recording real property interests and transfers thereof is well known. Local governments (e.g., counties) typically administer the recording system. Most any time a property owner transfers an interest in his property, a document evidencing the transfer is recorded in the county where the property is located, thus providing notice to others of who owns what interest in the property. The property owner may transfer all his right, for example, when an individual sells his primary residence, in which case a deed usually is recorded. In another example, a property owner may transfer only a right to foreclose on a mortgage if he does not make required payments, in which case a mortgage may be recorded. Those skilled in the art will appreciate other examples.

Before an entity (grantee) gives value in return for an interest in property, that entity typically desires to confirm that the property owner (grantor) has the right to transfer the interest. It is common practice for title companies to provide this insurance in the form of “title policies.” Essentially an “owner's title policy” is an insurance policy that insures the grantee against the risk of receiving a defective interest in property. Before issuing a title policy, a title company physically searches recorded property records to create a chain of title and identify potential encumbrances to effective transfer of any of the bundle of rights associated with the subject property. Likewise, before a lender lends money secured by property, the lender typically searches the property records to assess the quality of the collateral. Such lenders purchase a “loan title policy” to insure the lender against the risks of making a loan on a property with potential title problems. These are, of course, but two examples of instances in which searching property records is desirable, albeit probably the most common examples.

For a number of reasons, the process of searching property records is labor intensive. Property records typically are recorded in chronological order, not according to location, thus complicating the task of identifying recorded documents relating to a specific parcel from among the thousands of recorded documents. Further, any given parcel is a subdivided portion of a larger parcel and the property description is not consistent. Further still, a variety of documents are used to record transfers of property interests, and a standard format does not exist. Errors in recorded documents or in the indexing system used to locate the records further compound the problem. Current name indexing systems are based on exact matches or problematic soundex search techniques, which either miss records or return erroneous and not-applicable records. Probably most importantly, however, is the lack of an electronic data extraction and searching system that includes all the information an underwriter may need to know about a parcel before issuing a policy or approving a loan relating to the property.

There also exists a need for systems and methods for evaluating an entity's interest in property—i.e., the quality of the entity's title. Any number of events and circumstances may affect a property interest or the value of the property in which the interest is held. Partial transfers, transfers by fewer than all owners, liens, judgments, foreclosures, probate or estate issues, bankruptcies, mortgages, acts of law, civil actions, and the like are merely a few examples of these events and circumstances, many or all of which could be synthesized and summarized in a meaningful way if the data were available.

Yet another need exists for automating the title examination process to the extent possible, and guiding title examination processes that cannot be fully automated. Such systems could produce any of a variety of output documents.

Thus, embodiments of the present invention relates to systems and methods for improving the efficiency of property record searches, as well as analyzing and summarizing the results thereof, including systems and methods for evaluating the quality of an entity's title.

### BRIEF SUMMARY OF THE INVENTION

Embodiments of the invention thus provide a title examination method. The method includes receiving a request to examine title to a specific parcel. The request includes at least an identifier of the parcel. The method also includes extracting data from documents related to the parcel, assembling output by applying rules to the data extracted from the documents, and exporting the output to an external computer. The method may include using the identifier of the parcel to search a property records database to identify the documents related to the title to the parcel, thereby generating search linkages for each identified document and identifying relationships among the documents. Assembling output by applying rules to the data extracted from the documents may include applying the rules to the search linkages, the relationships among the documents, and the data extracted from the documents.

In some embodiments, assembling output by applying rules to the data extracted from the documents may include selecting a template relating to a rule. The template may include a conditional expression, evaluating the conditional expression, based on the evaluation of the conditional expression, selecting data elements from the data extracted from the documents for inclusion in the template, and including the template as part of the output. Assembling output by applying rules to the data extracted from the documents may include selecting a template relating to a rule. The template may include a conditional expression, evaluating the conditional expression, based on the evaluation of the conditional expression, generating an item for an exceptions file, for each item in the exceptions file, selecting data for transmission to a user computer, receiving a response from a user, based on the response, selecting data elements from the data associated with the documents for inclusion in the template, and including the template as part of the output.

In some embodiments, the output may be a purchase title policy, refinance title policy, prelim, title information report, abstract, purchase title commitment, refinance title commitment, document, data stream, and/or electronic transmission. Applying rules to the data extracted from the documents may include comparing a name on one or more documents with a name on one or more other documents. Applying rules to the data extracted from the documents may include comparing a name on one or more documents with a name associated with the request. Applying rules to the data extracted from the documents may include examining a chain-of-title associated with the parcel. Applying rules to the data extracted from the documents may include examining mortgages relating to the parcel. Applying rules to the data extracted from the documents may include examining encumbrances relating to the parcel. The request may include the documents, identifiers of the documents, and/or images of the documents. Extracting data from documents related to the parcel may occur prior in time to receiving a request to examine title to a specific parcel.

In still other embodiments, a title examination system includes means for receiving a title examination request. The request includes at least an identifier of a parcel. The system also includes automated means for extracting data from documents related to the request and a processor responsive to the request. The system also includes software that programs the processor to assemble output by applying rules to the data extracted from the documents and export the output to an external computer. The title examination system may include a property records database and the software may program the processor to use the identifier of the parcel to search the property records database to identify the documents related to the title to the parcel, thereby generating search linkages for each identified document and identify relationships among the documents.

In further embodiments, a computer-readable medium has stored thereon code for programming a processor to receive a request to examine title to a specific parcel. The request includes at least an identifier of the parcel. The computer-readable medium also has stored thereon code for programming the processor to extract data from documents related to the parcel, code for programming the processor to assemble output by applying rules to the data extracted from the documents, and code for programming the processor to export the output to an external computer.

In still other embodiments, a title examination system includes an interface to an external computer. The interface is configured to receive a title examination request that includes at least an identifier of a parcel. The system also includes a data extraction arrangement configured to extract data from documents related to the request, an output generation system configured to assemble output by applying rules to the data extracted from the documents and an interface configured to export the output to an external computer. The title examination system may include a property records database. The output generation system may be configured to use the identifier of the parcel to search the property records database to identify the documents related to the title to the parcel, thereby generating search linkages for each identified document, and identify relationships among the documents.

In some embodiments, the output generation system may be configured to apply the rules to the search linkages, the relationships among the documents, and the data extracted from the documents. The output generation system may be configured to select a template relating to a rule. The template may include a conditional expression. The output generation system may be configured to evaluate the conditional expression, based on the evaluation of the conditional expression, select data elements from the data extracted from the documents for inclusion in the template, and include the template as part of the output. The output generation system may be configured to select a template relating to a rule. The template may include a conditional expression. The output generation system may be configured to evaluate the conditional expression, based on the evaluation of the conditional expression, generate an item for an exceptions file, for each item in the exceptions file, select data for transmission to a user computer, receive a response from a user, based on the response, select data elements from the data associated with the documents for inclusion in the template, and include the template as part of the output. The output may include a purchase title policy, refinance title policy, prelim, title information report, abstract, purchase title commitment, refinance title commitment, document, data stream, XML elements, and/or electronic transmission. The output generation system may be configured to compare a name on one or more documents with a name on one or more other documents. The output generation system may be configured to compare a name on one or more documents with a name associated with the request. The output generation system may be configured to examine a chain-of-title associated with the parcel. The output generation system may be configured to examine mortgages relating to the parcel. The output generation system may be configured to examine encumbrances relating to the parcel. The request may include the documents, identifiers of the documents, and images of the documents.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a title searching and examining system according to embodiments of the system.

FIG. 2 illustrates a title search and examination process that may be implemented in the system of FIG. 1.

FIG. 3 illustrates a more detailed title examination process.

FIG. 4 illustrates a guided title examination process.

FIGS. 5A and 5B illustrate a Graphical User Interface (GUI) through which users may interact with the system according to some embodiments of the present invention.

FIG. 6 illustrates a title scoring process according to embodiments of the invention.

FIG. 7 illustrates an example of a title score report according to embodiments of the invention.

### DETAILED DESCRIPTION OF THE INVENTION

Embodiments of the invention provide systems and methods for evaluating title to property. As used herein, “title” will be understood to mean: 1) a combination of all the elements that constitute the highest legal right to own, possess, use, control, enjoy, and dispose of real estate or an inheritable right or interest therein; and/or 2) the rights of ownership recognized and protected by law. Generally “title” is synonymous with “rights of ownership.” Title could relate to any interest in property, including, for example, present possessory interests, future interests, contingent interests, and the like.

Title to real property is evidenced by recorded documents in most cases. Title examiners typically are engaged to evaluate title relating to specific property interests prior to those interests being transferred. The job of an examiner is to examine each of the conveyances or links in a chain of title to determine the validity of the title and to determine existing defects or outstanding liens, claims, or interests that can affect the ownership or possession of an interest being conveyed. “Chain of title” beings with the conveyance out of an original source of title, such as a government patent, grant, or lottery, and continues through each succeeding deed, will, operation of law, or other medium that conveys and transfers the title to a succeeding owner, each of which conveyances constitutes a link in the chain of title. Thus, the chain of title is the composite of all such links. In short, a chain of title is a list of names of the owners and the respective documents of conveyance of a particular parcel of real estate, as well as other interests and matters, relating to the parcel back to the original patent, grant, or lottery and the original parcel origin.

Embodiments of the invention disclosed herein improve the title examination process. In some embodiments, the present invention automates the process of title examination. The automated process may result in any of a number of output documents, including, for example, a title policy, a title commitment, a “prelim,” and the like. In some embodiments, the present invention applies “exception management” to the title examination process, thereby automating the process to the extent possible and employing a title examiner to review only examination items that cannot be resolved in the automated process. The examiner may be guided through the significantly abbreviated examination process. The outputs from these embodiments may be the same as those from the fully automated process. In still other embodiments, the present invention provides systems and methods for deriving a title score that summarizes a title evaluation process in a meaningful way.

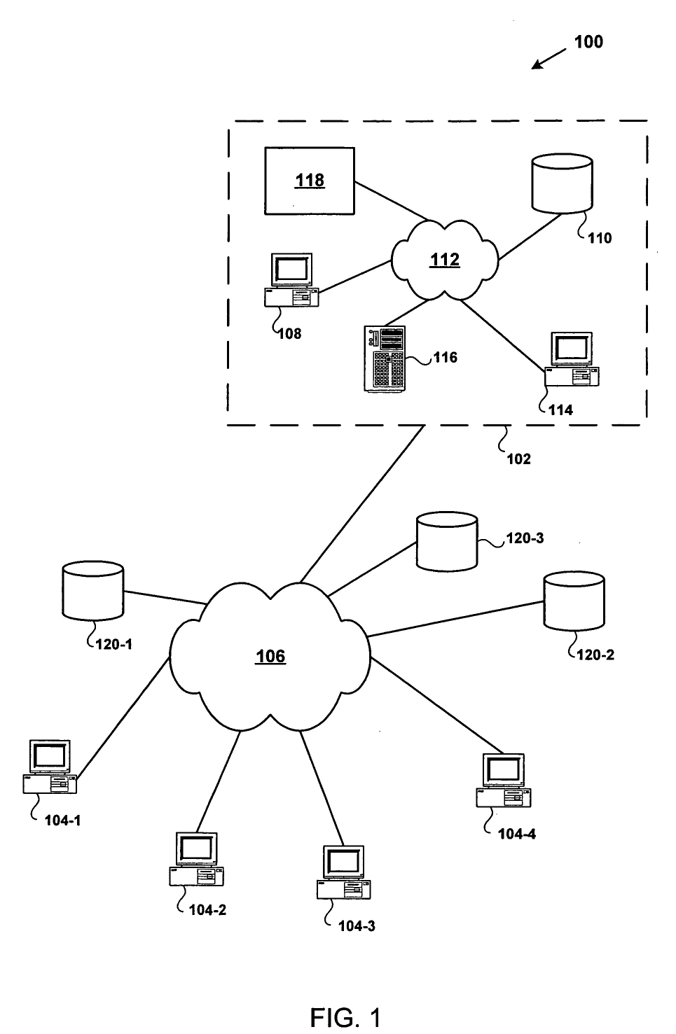

Having described embodiments of the invention generally, attention is directed to FIG. 1, which illustrates an example of a property records searching and examination system 100 according to more specific embodiments of the invention. The system 100 includes a host computer system 102. The host computer system 102 may include any of a number of computing devices, peripheral devices, network devices, input devices, output devices, and the like. All the devices that comprise the host computer system 102 may be co-located at a single facility or distributed geographically. Further, the host computer system need not be commonly owned or controlled. For example, examination and/or scoring functions may be performed at one location by a first entity, while search and organization functions are performed at a different location by a second entity. In a specific embodiment, the host computer system 102 is a single computing device that users 104 may access via a network 106. Many other examples are possible.

In a specific embodiment, the host computer system 102 includes a workstation 108, a data storage arrangement 110, and an internal network 112 that allow the two to communicate. The workstation 108 may be any computing device or combination of computing devices capable of performing the processes described herein. The workstation 108 includes a processor and software that programs the processor to operate according to the teachings herein. As is known in the art, the software may be stored on computer-readable media in the form of computer-executable instructions. In some embodiments, the software may reside on the storage arrangement 110. The storage arrangement 110 may be, for example, any magnetic, electronic, or optical storage system, or any combination of these. The storage arrangement may be a server, or combination of servers having RAM, ROM, hard disk drives, optical drives, magnetic tape systems, and the like or any combination. In some embodiments, each geographic region is represented by a server or group of servers. Many other examples are possible. The internal network 112 may be any of a number of well known wired or wireless networks or combinations thereof. For example, the internal network may be a LAN, WAN, intranet, the Internet, or the like. Many other examples are possible. The host computer system also may include administrative computers 114 (e.g., personal computers, laptop computers, and the like) that may be used to assist in the operation of the system. The host computer system 102 also may include network interfaces 116 (e.g., web server) that enable communication between the host computer system 102 and users 104.

The host computer system 102 also may include an input workflow process and system 118 (“input system 118” hereinafter). In its most basic form, the input system 118 receives source property records, converts the property records to searchable data, and delivers the data to the storage arrangement. This process will be described in greater detail hereinafter. The input system 118 need not be a single device, nor located at a single location.

The network 106 may be any wired or wireless network, or any combination thereof. In a specific embodiment, the network 106 is the Internet. The users 104 may be any computing device capable of providing a user access to the host computer system 102. In a specific embodiment, the user 104-1 is a desktop computer of an underwriter, an abstracter, an underwriter's agent, an examiner, or the like, through which the host computer system is accessed, via the Internet, for purposes of performing a search and underwriting a policy or loan for a customer.

The system 100 also may include one or more external databases 120. The external databases may be public record databases, land records databases, industry record databases, “starter file” databases (e.g., a database of previously-issued title insurance commitments, title policies, or the like), insurance claim databases, and the like. For example, the external database 120-1 may be a civil court record database for a specific county or other geographic region. This database may store information on civil proceedings such as marriages, divorces, bankruptcies, and the like. The database 120-2 may be, for example, an insurance database that stores information relating to insurance claims homeowners file. The database 120-3 may be a tax assessor's database that stores information relating to property valuations. Many other examples are possible.

Those skilled in the art will appreciate that the foregoing is but one example of a system according to embodiments of the invention. Many other examples are possible.

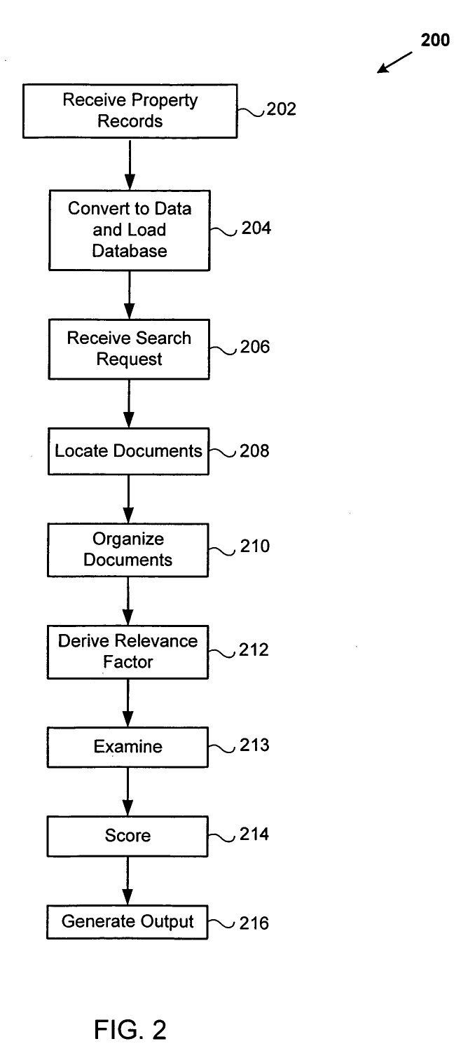

Having described an exemplary system according to embodiments of the invention, attention is directed to FIG. 2, which illustrates an exemplary method 200 according to embodiments of the invention. The method may be implemented in the system 100 described above or in another suitable system. Those skilled in the art will appreciate that alternative methods according to embodiments of the invention may include more or fewer steps and that the steps described herein may be performed in different orders than that described with respect to this exemplary embodiment.

The method 200 begins with the receipt of property records at block 202. The records may be received in any of a number of forms. For example, in some embodiments, the property records are received as paper copies of all documents recorded in a given jurisdiction. In other embodiments, the property records are received as a collection of image files. The image files may be stored in magnetic (e.g., on one or more computer disks) or optical (e.g., on one or more CDs) form, or the like, or a combination of such. The image files may include microfilm or microfiche images. Many other examples are possible. The property records may include deeds, conveyances, mortgages, liens, releases, assignments, maps, judgments, bankruptcy records, foreclosures, probate records, and the like.

At block 204, the property records are converted to data and loaded into a database such as the storage arrangement 110 of FIG. 1. This may involve use of the input system 118 of FIG. 1. This process is described in greater detail in previously-incorporated provisional U.S. Patent Application No. 60/554,511 (Attorney Docket No. 040143-000100).

At block 206, a search request is received. In a specific embodiment, this comprises receiving a request via a network (e.g., the Internet, or other network represented by the network 106 of FIG. 1) from a user, such as one of the users 104 of FIG. 1. The request may comprise one or more data elements on which the user would like to base the search. Exemplary data elements include the property address, a legal description of the property, survey information (lot, block, subdivision, condo, section, township, etc.), the grantor or grantee in a property transaction, and the like. In some embodiments, the user may supply a specific document (e.g., by providing the instrument/reception number of the recorded document) on which the user desires the search to be performed. In a specific embodiment, the inputs include: at least one normalized (i.e., including platted, sectional, and/or metes and bounds information) property location; at least one current property owner name; and/or at least one document identifier (e.g., reception number, instrument number, volume/book/page, and the like). The inputs may include: one or more property address that relate to the normalized property location; and/or one or more parcel identifiers that relate to the normalized property location.

At block 208, potentially-relevant documents are located. This process is described more fully in previously-incorporated U.S. patent application Ser. No. 10/804,468 (Attorney Docket No. 040143-000300). Briefly, however, this comprises locating within the stored property records documents potentially related to the data elements in the user's request. The documents thus form a set of potentially-relevant documents.

Documents selected for inclusion in the set of potentially-relevant documents include, in a specific embodiment, one or more of the following fields:
Normalized field data, such as: identifying numbers (reception, instrument, volume/book/page); recordation date; document type/title; other additional data captured in electronic form from a source document;
Normalized name such as grantor, grantee, third party and/or fourth party information written on the source document and digitally captured and associated to each document;
Normalized location data such as information written on the source document and digitally captured and associated to each document. This location data may be transformed from the legal description, if any, from each source document;
Normalized document references written on the source document and digitally captured and associated to each document. This reference data may be transformed from the previous reception/instrument or volume/book/page data found within legal descriptions or otherwise located on the source documents. Document references can be for RE-RECORDED and CORRECTED/AMENDED documents and the reference is usually previous reception/instrument or previous volume/book/page;
Normalized address(es) written on the source document and digitally captured and associated to each document. This address data may be transformed data found within legal descriptions, or otherwise located on the source documents, from tax assessor or tax treasurer database(s), or the like;
Normalized parcel identifiers written on the source document and digitally captured and associated to each document. This parcel identification data may be transformed data found within legal descriptions or otherwise located on the source documents.

Each instance of a potentially-relevant document being located results in the creation of a search linkage. A search linkage relates to how the document was selected for inclusion in the potentially relevant document set. For example, if a document was selected for inclusion because of a match or near match with respect to name (i.e., a name on the document matches a name provided by the user), then the resulting search linkage identifies the match to be based on name. Other search linkages may relate to, for example, property address or legal description matches or near matches. Further, matches may be with a user-supplied input, with another potentially-relevant document, with re-recorded or corrected/amended document, and/or the like. Further still, search linkages may include a confidence factor that provides some indication of the degree of match between the two elements. Useful purposes relating to the confidence factor will be described in more detail hereinafter.

In a specific embodiment, the search linkages associated with a specific document include one or more of the following:
Document found by name match. A confidence number may be associated with this search linkage, e.g. 100% match, or 95% match. Documents are matched by name using the names provided as operator inputs;
Document found by location match. A confidence number may be associated with this search linkage, e.g. 100% match, or 95% match. Documents are matched by location using the location data provided as operator inputs;
Document found by hierarchically containing location match. A confidence number may be associated with this search linkage, e.g. 100% match, or 95% match. Documents are matched by location using the location data provided as operator inputs. Hierarchically containing locations are those that are broader in scope than the input locations, but match a broader subset of the data elements in the input locations, e.g. matched on subdivision and block, with no lot.
Document found by bridged location match. A confidence number may be associated with this search linkage, e.g. 100% match, or 95% match. Documents are matched by bridged location using the location data provided as operator inputs. A bridged location matches as above, but also possesses “bridging” information to an alternate means of representing the location, e.g. the location matches on lot/block/sub, but also contains sectional descriptions of a property.
Document found by replatted location match. A confidence number may be associated with this search linkage, e.g. 100% match, or 95% match. Documents are matched by replatted location using the location data provided as operator inputs. Re-platted locations are similar to bridged locations, but the location data specifies that, for example, a lot/block/sub was replated from a previous subdivision (and/or lot/block/tract);
Document found by reference FROM another document;
Document found by reference TO another document;
Document found by address match. A confidence number may be associated with this search linkage, e.g. 100% match, or 95% match. Documents are matched by address using the address data provided as operator inputs;
Document found by parcel identification match. A confidence number may be associated with this search linkage, e.g. 100% match, or 95% match. Documents are matched by address using the address data provided as operator inputs;
Document found by exact identification match, where the document matches either the operator provided identifiers, or the document matches a document already in the result set exactly, by identifier.

Once located, potentially-relevant documents are organized at block 210. Organizing documents is more fully described in previously-incorporated U.S. patent application Ser. No. 10/804,467 (Attorney Docket No. 040143-000400). Briefly, however, this involves any of a number of processes that correlate documents in a manner previously accomplished manually. For example, this may involve matching mortgages with mortgage releases, matching liens with lien releases, constructing a chain of title, locating a good stop for a chain of title, matching multiple grantees in a transfer to grantors in a subsequent transfer, and the like. Organizing documents may, in some embodiments, result in organizational linkages that, as with search linkages, provide an indication of the organizational relationship between documents.

At block 212, the search linkages and/or the organizational linkages are used to derive a relevance factor for each document in the set of potentially-relevant documents. The relevance factor may be a number, a letter, or any other identifier that locates the relevance of a document with respect to other documents or criteria.

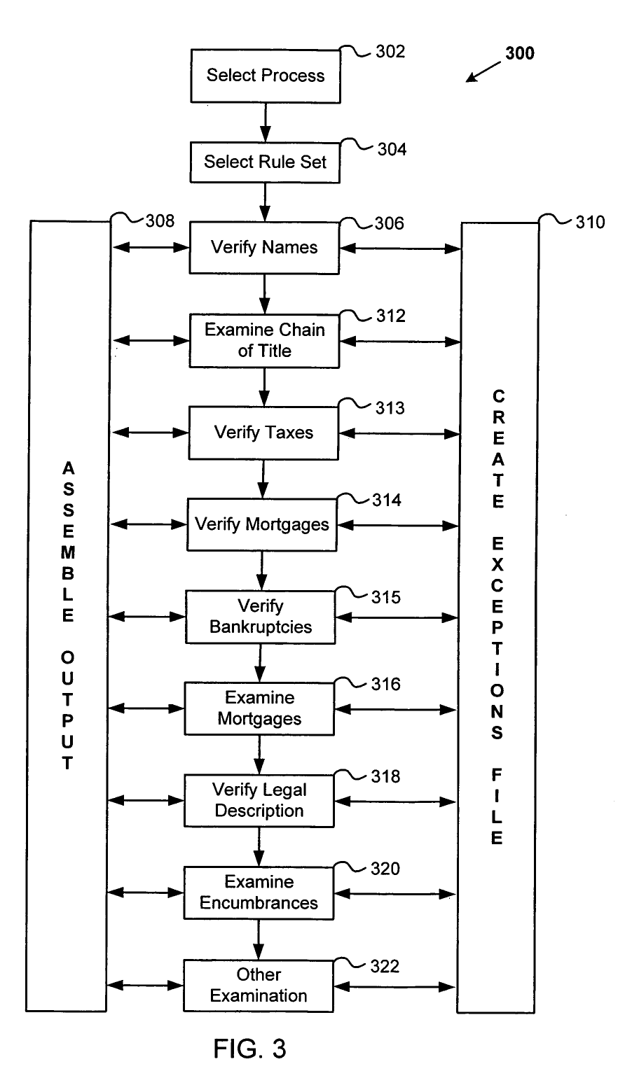

At block 213, the results set is examined. The results set includes: any or all of the potentially relevant documents; the respective search linkages for the potentially relevant document; the data associated with the potentially relevant documents; organizational linkages; the elements from the user request; tax assessor/treasurer records, civil judgments relating to the parcel or the parties; bankruptcy judgments; and the like. A specific embodiment of an examination process is illustrated in FIG. 3 and will be described in more detail hereinafter. Briefly, however, examination comprises evaluating the existing data set and assembling the requested output document or documents. The examination process may be fully automated or may include a guided examination process. The examination process may apply one or more rule sets that may be customer specific, task specific, geographically specific, or the like.

As is known in the art, rules may be written in any of a number of programming languages and may perform any of a number of functions. In general, however, rules contain inputs, expressions, and outputs. An exemplary rule for reporting a corrective deed follows:

( ( IF {FieldName.DT_BOOK} = NULL ) AND
(IF {FieldName.DT_PAGE} = NULL ) AND (IF
{FieldName.DT_RECEPTIONNUMBER} = NOT NULL ) )
AND
(
( IF {METASUB.DEDAMD CORRECTED WARRANTY DEED} OR
IF {METASUB.DEDCOR CORRECTED DEED} OR
IF (METASUB.DPRCOR CORRECTED PERSONAL
REPRESENTATIVES DEED} OR
IF {METASUB.QCDCOR CORRECTED QUIT CLAIM DEED} OR
IF {METASUB.AFFCOR AFFIDAVIT OF CORRECTION} )
OR
( IF {FieldName.DT_CORRECTEDAMENDEDBOOLEAN} = TRUE
FOR DOCUMENT RETURNED IN
{DT_CATEGORY.CONVEYANCE} )
)
THEN {ValidOutputResult.TextPlacementAndSubstitution = “Correction
deed recorded {FieldName.DT_RECORDING_DATE} as
Book {FieldName.DT_BOOK} at Page {FieldName.DT_PAGE},
to {FieldName.DT_CORRECTEDAMENDEDREASON}.”} of
{MacroCode.AB157-BKPG} AT {TargetLocation}

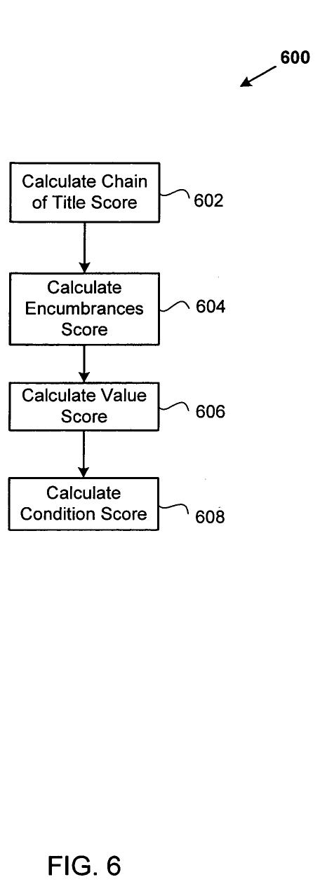

At block 214, a title score is calculated. The title score may be any character or combination of characters (e.g., a letter grade, a vector or matrix of numerical scores or letter grades, a numerical score, +++, ++−, +−−, etc.) that provide an indication of the quality of title under examination. In some embodiments, score components have weighting or importance factors or the like applied to them. The factors may be customer defined and customer specific. An embodiment of a process for calculating a title score is illustrated in FIG. 6, and will be described in more detail hereinafter.

At block 216, output is generated. Output may include any of a number of documents related to title examination. Examples include: a title commitment for a purchase; a title commitment for a refinance; a title policy for a purchase; a title policy for a refinance; a title “prelim”; a title information report; an examined abstract; an Owner's and Encumbrance Report (O&E); a Current Owner Search; a Deed Report; or the like. The output may include a list of documents related to the user request. The output may include the title score. In some embodiments, the title score is the primary output other than general information relating to the request.

The output may take any of a wide variety of forms. The output may be an electronic file or transmission stream (which may include one or more documents, one or more .XML files, .XML “tagged” data elements, and the like) transmitted from the host computer to a user computer. The electronic file may comprise documents in final form, suitable for printing. Document formats may include, for example, text files, .pdf documents, and the like. In other embodiments, however, the electronic file may comprise data for inclusion in other documents prepared at the user computer. In still other embodiments, the output is printed from the host computer and mailed or otherwise transmitted to a recipient. Many other examples are possible and apparent to those skilled in the art in light of this disclosure.

Those skilled in the art will appreciate that alternative methods according to embodiments of the invention may include more, fewer, or different steps than those illustrated and described here. Further, steps may be performed in different orders than that described with respect to this exemplary specific embodiment. For example, a pre-score may be calculated before examination or at some other point in the process; examination may be performed on data received from an external source; examination results may be sent to an intermediary, such as a source of data, rather than to a user; and other examples, as is apparent to those skilled in the art in light of this disclosure.

Having described an exemplary method according to embodiments of the invention, attention is directed to FIG. 3, which illustrates a specific embodiment of a title examination method 300. The method begin may comprise block 213 of FIG. 2. The method begins at block 302. At this location, an examination process is selected based on the request received at block 206 of FIG. 2. The examination process and associated rules may be different, for example, depending on what type of output the user has requested. A different examination process and rule set may be used to generate a commitment for a purchase rather than to generate a policy for a refinance. A different process and rule set may be used for different geographic regions. A different process and rules set may be used for a different underwriter, a different product output, a different member/user, and the like, and rules may be administered in these ways. Further still, a different process/rule set may be used if the user has merely requested a title score. Many other examples are possible.

At block 304, a rule set is selected based on the user request. The title examination process is guided by rules and associated expressions. The rules may be customer specific, product (i.e., output) specific, underwriter specific, geographically specific, and/or the like. The selected rule set determines the content of the final product. In this specific example, rule types may include (1) text substitution rules, where templates containing fixed and variable text (e.g., {FieldName.DT_BOOK}) are inserted at {target locations}; or (2) exception and requirement mapping rules, which create linkages between text substitution placement in two or more locations within a specified output document. Many other examples of rule types are apparent to those skilled in the art in light of this disclosure.

At block 306, the examination process begins. The examination process consists of a number of tasks. Initialization rules may be executed before any task is performed to attempt to automate certain aspects of the process and to determine which exceptions are to be generated that may require manual intervention. For each task, initialization or other rules are applied to items in the results set. The examination tasks may be ordered in any of a number of ways. In some embodiments, a document is selected from the result set and each task is performed on the document, after which another document is selected. In other embodiments, a task is performed on each document, then the process moves to the next task, which is performed on each document, and so on. In still other embodiments, the examination process proceeds from document-to-document following the chain of title. Many other examples are possible, including the case where only certain tasks are performed on certain document types. Further, based on inputs from a user, other rules may be applied. additional information collected allows the application of other rules. For example, the most recent conveyance may be used to obtain the legal description, the latest mortgage for name verification, and the like. Further still, rule sequencing may be configured by administrative interfaces controlled and administered by a qualified administrator.

In most embodiments, the rules comprise a conditional statement followed by an action to be taken based on the outcome of the conditional statement. The action may be the completion of a text template for inclusion in an output file. An example of a conditional statement compares names and places name text on an output document. To wit: “If {name on document A}={user-supplied name} then {insert the name} {at location 1 of the title policy}.” Of course this is a most basic form of such a rule, and those skilled in the art will appreciate many other examples in light of this disclosure.

Rules may be complex statements and may operate on any item or items in the results set. The outcome may be the placement of only a few words of text or the outcome may consist of entire paragraphs of text with a few key words from the results set being placed in variable fields within the text. In some embodiments, rules result in the need to apply additional rules to the result set. In other embodiments, rules result in linkages amongst related text substitutions in different target locations. In other embodiments, rules may reference internal of external tables of data (such as statutes of limitation tables by state and by scenario) in order to complete a rule or expression.

The iterative process of applying rules to the result set assembles the output. The output, which may be a file, a document, a data stream, and/or the like, as mentioned previously, may be any of a variety of title-related documents or data (e.g., .XML tagged information). If the output is a title policy for a purchase, for example, the text template may create an exception to coverage. If the output is a title commitment for a purchase, for example, the text template may create a requirement to be met before a title policy can be issued. Many other examples exist.

In some cases, a rule cannot be resolved automatically, which creates an exception that must be handled by an underwriter or other user (this use of “exception” here is not to be confused with a policy exception that excepts particular items from coverage. Here, exception refers to an exception to the automated process that requires human intervention as is the case where “exception management” is applied). Exceptions are often created when rules are applied and ambiguities remain, which may generate the need for an examiner to manually review a recommendation made or the entire data set and determine which text substitution, for instance, should be used. Exceptions are moved to an exceptions file for further processing as will be described more fully hereinafter.

Thus, at the beginning of the examination process at block 306, in this embodiment, names are verified. This may be accomplished in any of a number of ways. In some embodiments, this is accomplished by comparing names on each document, in turn, to the name(s) provided in the user's request. Matches within a certain confidence interval may result in the completion of a template, that includes the name(s), and the placement of the resulting text at a specific location in an output file as indicated by block 308.

When text is placed in an output file or data stream, text may be fixed or variable. For example, fixed text may be embedded with merged variables that are taken from a database and inserted within the fixed text based on the rule. In some cases, the user must type text for certain variable fields that do not have a corresponding entry in the database, but for which the data can be found on the document to which the data relates. In some embodiments, data that was not previously extracted from a document for inclusion in the database may be extracted for inclusion as part of the output.

As mentioned previously, if a rule cannot be resolved automatically, an item is added to an exceptions file at block 310. Such may be true with each application of a rule for each task in the examination process.

At block 312, the chain of title is examined. This may comprise examining each conveyance, starting with the most recent, and continuing backward in time to an original grant. The process may be repeated in chronological order. For each conveyance document, rules may be applied, for example, to see if all rights from the prior or later conveyance were transferred, if all owners transferred their rights, if deed requirements by state were met (notary, signature, and other deed requirements), and the like. Rules that can be resolved generate text for the output file or data stream at block 308, and rules that cannot be resolved result in an item being added to the exceptions file.

At block 313, tax records are verified. This may comprise, checking public record databases to determine if taxes are owed, due soon, and/or the like. Based on this, one or more exceptions may be generated or output may be assembled.

At block 314, mortgages are verified. This may comprise examining each mortgage document to confirm that it relates to the parcel described in the user's request. At block 315, public records may be examined to determine whether parties to the conveyance of the property has been the subject of a bankruptcy. This may be followed by mortgage examination at block 316, at which location each mortgage document is paired with a document that cures it (e.g., releases it, partially releases it, subordinates it, modifies it, assigns it, and/or the like). Uncured mortgages may result in a text being added to the output file identifying a coverage exception or curing condition that must be satisfied relating to the uncured mortgage.

At block 318, legal descriptions are verified. This may comprise ensuring that each conveyance transfers all of the property in question. This also may comprise checking that the ASCII text of the legal description that has been typed or recognized with Optical Character Recognition (OCR) matches the text shown either in the image of the legal description or on the original paper legal description in the document. Later conveyances may transfer only a portion of a previous conveyance that transferred a larger parcel, such as when land is subdivided. Thus, each legal description may be examined for these and other matters.

At block 320, other encumbrances are examined. This may include matching each encumbrance (e.g., lien, judgment, lis pendens, mechanic's lien, etc.) with its curing document or partially-curing document. It may also include ignoring encumbrances no longer in effect due to a statute of limitations. This can be done, for example, by comparing the record or document date with the applicable data in a statutes of limitations table by state and/or by scenario. As with previous operations, resolvable rules may create items to be included in the output file, while irresolvable rules result in an exception being added to the exceptions file.

At block 322, other examination tasks may be accomplished.

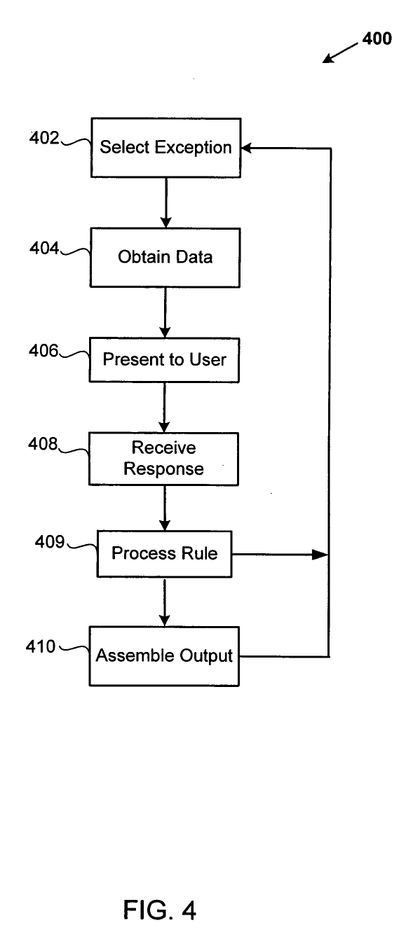

Those skilled in the art will appreciate that alternative methods according to embodiments of the invention may include more or fewer steps, and that the steps described herein may be performed in different orders than that described with respect to this exemplary specific embodiment. For example, the exception resolution process 400 to be described immediately hereinafter may be performed concurrently with the ongoing automated examination process. In still other embodiments, no item is resolved automatically and the entire examination process proceeds according to the process 400 of FIG. 4. In such embodiments, the process described herein could be considered “guided title examination” as opposed to “automated title examination.” Thus, embodiments of the invention span the entire spectrum of possibilities described herein from completing an examination process without human intervention to guiding an individual through every step in the process.

Attention is directed to FIG. 4, which illustrates an example of an exception resolution process 400 according to embodiments of the invention. The process operates to resolve the examination exceptions compiled into an exceptions file at block 310 of FIG. 3. “Exceptions file” is to be interpreted broadly to mean a collection of one or more examination exceptions regardless of whether they are co-located electronically into a common file.

In some embodiments, the exception resolution process 400 iteratively resolves exceptions directly with the user (who may be an examiner or underwriter or the like) who initiated the request. Alternatively, however, several options exist. In one alternative, exception files are queued for review by the next available examiner. When one is available, the exceptions file is sent to the available examiner for processing. In other embodiments, individual exception items are queued for resolution and a single examiner does not necessarily resolve all exceptions for a single request. In some embodiments, each exception item or each exception file is directed to examiners based on levels of experience and/or authority. For example, “simple” files, such as those having no chain-of-title breaks and no encumbrances, may be sent to the least experienced examiners. In such embodiments, the examiner's proficiency level may be set by an administrator and controlled using a graphical user interface that directs workflow. Other examples exist.

The exception resolution process 400 begins at block 402 where a specific exception is selected for resolution. As explained previously, this may comprise selecting an entire exceptions file from a queue or a single exception from an exceptions file. Once selected, relevant data for resolving the exception is compiled at block 404. Lists of exceptions may be dynamically hyperlinked to scanned images in some embodiments to make examination of them efficient. The data may come from the result set, and may include images of recorded documents or portions thereof. For example, if a name comparison cannot be resolved automatically, thus generating an exception, the data obtained in this block 404 may include an image file containing the portion of the document that includes the name. Other data may include the name supplied by the user in the initial request. Other examples are possible.

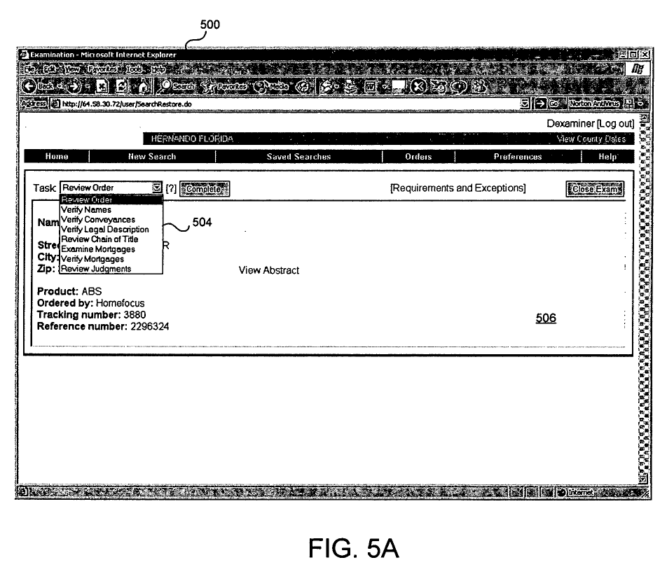

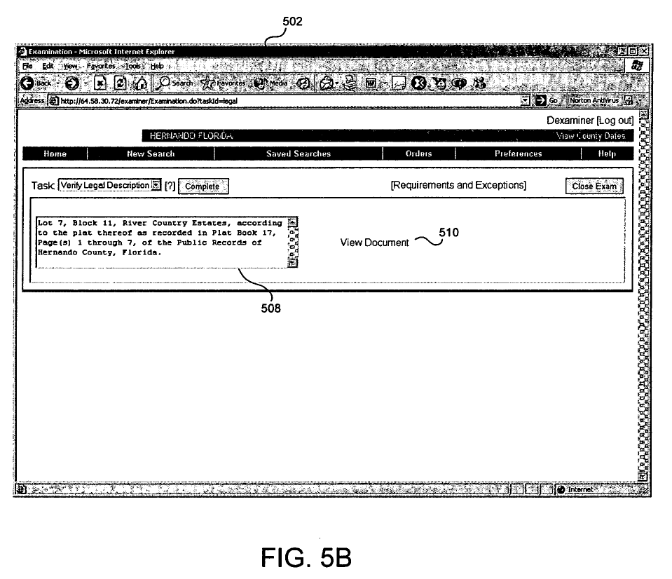

At block 406, data to resolve the exception is presented to a user. As will be described in greater detail hereinafter with respect to FIG. 5, presenting the data to the user may include using a graphical user interface (GUI) to simplify the process. The GUI may present the relevant data in a meaningful way and provide one or more buttons, check boxes, menu selections, easy comparison mechanisms, or the like, to receive the user's response. In some embodiments, extracted data fields from two linked documents are displayed side by side for easy comparison. Access to the scanned image of each document displayed in the GUI makes this comparison even easier so that the user can move on to the next examination task. Continuing with the previous example, if a name conflict exists and the user is being asked to verify the name on the document with the name supplied in the initial request, the GUI may present the image of the name from the document, together with the name supplied in the request, and ask the user if the names match. The user would then click a checkbox for “yes” or for “no” to resolve the exception. Many such examples exist and are apparent to those skilled in the art in light of this disclosure.

At block 408, the user's response is received and the rule is processed at block 409. Based on input from the user, output may be assembled at block 410. This operation is similar to block 308 of FIG. 3, except that the examination item was completed by an individual, rather than by the host computer in the automated process. Thus, the user's response may result in a template being completed that pulls data from the result set and includes it together with other text in the output document. In some embodiments, processing the rule at block 409 may result in additional rules being applied and/or generated.

Those skilled in the art will appreciate that alternative methods according to embodiments of the invention may include more or fewer steps, and that the steps described herein may be performed in different orders than that described with respect to this exemplary specific embodiment.

Attention is directed to FIGS. 5A and 5B, which illustrate two screen displays 500 and 502 relating to one embodiment of a GUI for accomplishing the exception resolution process 400. As is now apparent, the same GUI may guide an examiner through the complete examination process without first creating an exception file. The GUI is rendered on a computer screen or other user device that allows the user to interact with the host computer system to complete the process. Those skilled in the art will appreciate that the screen displays 500, 502 are merely exemplary screen displays from the many the GUI will produce in the course of an examination process. Further, the GUI illustrated and described herein is merely exemplary of a number of possible GUIs, as is apparent to those skilled in the art. The GUI 500 may be rendered in a web browser, as shown, or may be comprised by a standalone application, or the like.

In this specific example, the GUI 500 includes a drop-down menu 504 from which an examiner selects a task. The task may relate to an exception in an exception file or may simply be a standard task that should be completed before a particular output can be completed. Once the task is selected, information relevant to the task is displayed in a display area 506.

Referring now to FIG. 5B, the display area 506 includes information related to the task “Verify Legal Description.” The display area includes a text area 508 that contains the legal description as stored in the database. The text area is editable. The display area also includes a button 510 that hyperlinks to an image of the document from which the legal description was taken. Thus, the examiner may select the button 510 to view the image then compare the legal description from the image with the legal description as stored in the database. If the two match, the task may be considered complete by selecting a “complete” button. If not, the examiner may edit the text of the legal description in the text area 508.

Once the task is complete, text may be placed in output, rules may be processed that add new tasks and/or remove other tasks. The examiner then may select another task to continue the examination process.

In a specific embodiment, the GUI includes any or all of the following features:
possible encumbrances (e.g., outstanding mortgages/deeds of trust/security deeds, liens, judgments, lis pendens, claims, or interests that affect the ownership or possession of the interest being conveyed) are displayed for review by the user/examiner;
hyperlinks are used to provide direct access to the source (e.g., images of the actual document or portion thereof) from which data was abstracted;
organization linkages are displayed in graphical form, thereby allowing an examiner to determine the linkage's relevance to title, verify the linkages that were automatically determined, examine probable curing linkages to make a final determination, examine partial release linkages, examine clouded title linkages, and the like. Such linkages include; assignment linkages; positive curing linkages; probably curing linkages, where additional examiner provided examination is required to verify this curing; chaining linkages; correction linkages; corrected/amended linkages; re-recording linkages; mortgage linkages; first mortgage linkages; null release linkages; partial release linkages; and the like;
documents determined not to be relevant due to state-specific statute of limitations are displayed along with the corresponding recording date/document date on each document, thereby allowing the examiner to verify that the document no longer affects title;
a user-configurable checklist for the examiner to follow is displayed, thereby improving consistency and thoroughness in the examination process;
allows the examiner to specify importance/severity of each item in the checklist to aid in prioritization;
allows user to view assembled document at any time;
ability to view exceptions for a title commitment or title policy at any time;
ability to view requirements for a title commitment at any time;
allows the examiner to specify importance/severity of each item in the checklist to aid in prioritization;
includes color codes based on the importance/severity and re-prioritizes;
allows the examiner to elevate/re-direct a task in the checklist to a more proficient examiner (with attachments of documents, etc.). The user can flag an item and post it to a queue of a more proficient examiner;
provides hyperlinks to the general sections of an Abstract Sheet and the data contained in each to aid in the examination process along with hyperlinks from each element on the abstract sheet to the source document and specific mark-up regions to aid in examination;
provides for the creation of electronic “sticky notes” on documents that allow hyperlinking to resolve remaining examination issue after further research;
graphically displays the Chain-of-Title that is automatically and chronologically constructed, so that the examiner can follow ownership/conveyance of the subject property back to patent and quickly hyperlink to all relevant documents that affect title in each “link” in the chain;
provides a mechanism for “marking” each “link in the chain” with defects from a list provided in the graphical user interface and providing notes for future/subsequent examination;
provides hyperlinks directly to tax and treasurer information for the relevant county of the subject property;
provides hyperlinks directly to bankruptcy information for the relevant state/county of the subject property;
provides hyperlinks directly to Starter Files (CCRs) that are relevant to the subject property (where titles have been previously examined up to a certain date by reliable examiners, title companies sometimes give subsequent examiners of such titles a letter which sets forth the condition of the title at the time of the previous examination and authorizes them to begin their subsequent examination with the terminal date of the previous examination. The relevant information used for the prior examination is stored in “starter files,” which are also known as “back title letter,” “back title certificate,” or “base file”);
provides hyperlinks to directly access Name Attributes for documents returned in the search—that are relevant to the Chain of Title—and that often signal the need for certain specialized exceptions for a title policy or specialized requirements for a title commitment. A checklist and/or flags indicating any documents that need further examination due to the existence or non-existence of certain name attributes is provided with the ability to hyperlink to the documents (or to the relevant section of the Abstract Sheet) and to the exact field code mark-up boxes that were the source of the Name Attributes;
provides for a graphical user interface that streamlines the process of verifying deed requirements for each deed in the Chain of Title, with access to a knowledgebase of Deed Requirements by State.
provides for a graphical user interface that streamlines the process of “SAME AS DEED” signature validation for mortgages/deeds of trust/security deeds; and
provides for a comparison of ASCII signatures and the actual signatures contained above the mark-up boxes, to aid in examination.

Attention is directed to FIG. 6, which illustrates one example of a method of deriving a title score 600 in accordance with embodiments of the invention. The method 600 may comprise block 214 of FIG. 2. The score summarizes the quality of title in a meaningful way, thereby allowing certain decisions to be made with reference only to the title score.

It should be appreciated that many alternatives exist for calculating a title score. Some alternatives may be appropriate for some circumstances and not for others. Further, individual customers may specify their preferred method for calculating the title score. Thus, the same system may be used to calculate a title score using different methodologies.

The data from which the title score is calculated may comprise the result set described previously with respect to examination. In some embodiments, the result set may include additional data that results from the examination process. This may include both automatically-generated data, as well as examiner-supplied information. In some embodiments, the score may be annotated to indicate it as a pre-examination score or a post-examination score.

In this specific embodiment, the title score is a number from 0 to 100. Further, in this specific embodiment the score comprises point totals in four categories: chain-of-title; encumbrances; property condition; and valuation. In this example, the four categories each have a different weight.

The process 600 begins at block 602 where a chain-of-title score is calculated. In this embodiment, the chain-of-title score is a number from 0 to 40. If the chain-of-title has no breaks and/or no incomplete conveyances back to a good stop (i.e., the current owner has “clear” title), then the score will be at the higher end of the range. The score may be reduced for circumstances such as having a large number of links to a good stop, large numbers of parties to conveyances, non-standard conveyances, discrepancies with respect to name mismatches on deeds, related party conveyances, deed types (e.g., quit claim vs. warranty deed), state deed requirement non-adherence or adherence, and the like. Many other possibilities exist.

At block 604, a score is calculated for encumbrances. The encumbrances score is a number between 0 and 30 in this specific example. A baseline score of 30 may be selected for unencumbered properties. Each encumbrance may reduce the baseline score, the degree of reduction being determined by the type of encumbrance. Thus, a mortgage may significantly reduce the score. An allowance may be made if the mortgage is owed by the current owner. Uncured liens, judgments, and the like may significantly reduce the score. Liens beyond the statute of limitations for the jurisdiction, however, may not affect the score. Unpaid or partially paid taxes also may affect the score negatively. Many other examples exist.

At block 606, a valuation score is calculated. The valuation score, in this specific example, is a number between 0 and 20. It represents the present value of the property and may be adjusted to reflect the value as compared to any outstanding encumbrances. The valuation may be obtained from tax assessors or tax treasurers records, recorded appraisals, Automated Valuation Method (AVM) results, and the like. Thus, a property having outstanding loans in excess of its value may significantly reduce the score. Other examples exist.

At block 608, a property condition score is calculated. The property condition score is a number between 0 and 10 in this specific example. The score may include information from an insurance industry database, which may include insurance claims that may have been filed on the property. For example, if the property contains a structure which has been determined to have mold or termites, water damage, fire damage, or the like, then the score may be adjusted accordingly. Many other examples may exist.

For example, the score could be provided as a grade (A-F) or as a score, much like a credit score 0-800. The score could be made up of numerous components or pieces of the pie and weighting can be applied to any “slice” of the pie to come up with a score, based on the importance of each sub-component. In addition to the score, notes could be provided for each section or slice to give further insight.

In another specific embodiment, a title score comprises the following subjects and sub-component:
Clear Title/Vesting
   Does the name on the search order EXACTLY match the name in title on the vesting deed?
   Any other discrepancies?
   Is there any curative work required?
Encumbrances
   Are there Open Mortgages, Deeds of Trust, or Security Deeds?
   Are there Liens, Judgments, Lis Pendens, UCC filings, Federal Tax Liens, State Tax Liens, Divorce Judgments?
      Open?
      Released by Statutes of Limitations?
   Taxes
      Paid?
      Partially Paid?
      Delinquent?
Mortgage Releases and Payoffs
   Does a mortgage payoff have to go to an outside party?
Chain of Title
   Good Stop Type?
   No related parties conveying to one another?
   No clouds found or no broken links in chain?
Insurance Database Score
   Have there been any claims on property for mold, fire, water damage, fire damage, etc?
      Paid Claims?
      Claims not covered?

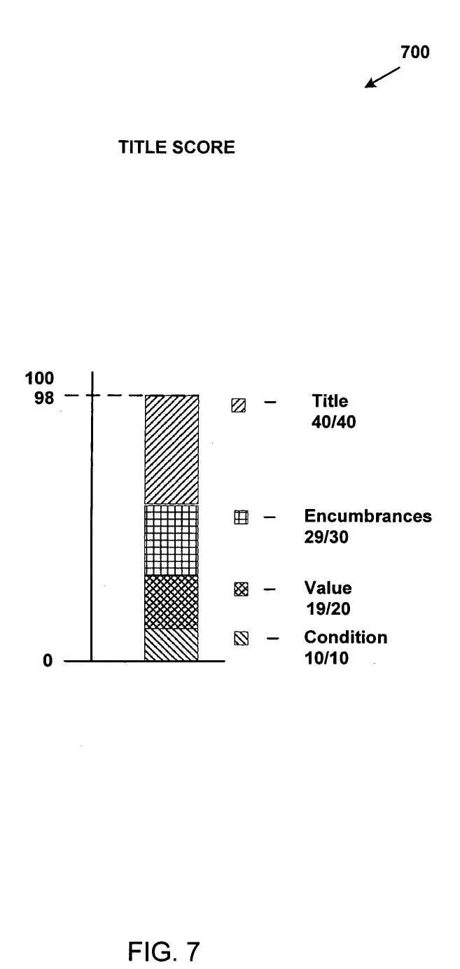

Once calculated, the score may be displayed as part of the output presented to the user. The score may be emailed, viewed on a website, faxed, or otherwise transmitted to the requester. Conveniently, the score may be illustrated as a bar graph, vector, matrix, or the like, that provides a total score, as well as each subcategory score. Further, details may be provided explaining the reasoning for the score, along with a legend for each category and subcategory so it is clear to the receiver where the score fits on the overall scale and what the score means. One example of such a graph is illustrated in FIG. 7.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to real property records searching specifically or property records searching generally. For example, the present invention may be used to search and examine corporate filings, license records, and the like. Accordingly, the above description should not be taken as limiting the scope of the invention, which is defined in the following claims.

1. A title examination method, comprising:
at a host computer system, receiving a request to examine title to a specific parcel, wherein the request comprises at least an identifier of the parcel;
at the host computer system, extracting data from documents related to the parcel;
at the host computer system, assembling output by applying rules to the data extracted from the documents; and
exporting the output to an external computer.

2. The method of claim 1, further comprising:
using the identifier of the parcel to search a property records database to identify the documents related to the title to the parcel, thereby generating search linkages for each identified document; and
identifying relationships among the documents.

3. The method of claim 2, wherein assembling output by applying rules to the data extracted from the documents comprises applying the rules to the search linkages, the relationships among the documents, and the data extracted from the documents.

4. The method of claim 1, wherein assembling output by applying rules to the data extracted from the documents comprises:
selecting a template relating to a rule, wherein the template includes a conditional expression;
evaluating the conditional expression;
based on the evaluation of the conditional expression, selecting data elements from the data extracted from the documents for inclusion in the template; and
including the template as part of the output.

5. The method of claim 1, wherein assembling output by applying rules to the data extracted from the documents comprises:
selecting a template relating to a rule, wherein the template includes a conditional expression;
evaluating the conditional expression;
based on the evaluation of the conditional expression, generating an item for an exceptions file;
for each item in the exceptions file, selecting data for transmission to a user computer;
receiving a response from a user;
based on the response, selecting data elements from the data associated with the documents for inclusion in the template; and
including the template as part of the output.

6. The method of claim 1, wherein the output comprises a selection from the group consisting of purchase title policy, refinance title policy, prelim, title information report, abstract, purchase title commitment, refinance title commitment, document, data stream, and electronic transmission.

7. The method of claim 1, wherein applying rules to the data extracted from the documents comprises comparing a name on one or more documents with a name on one or more other documents.

8. The method of claim 1, wherein applying rules to the data extracted from the documents comprises comparing a name on one or more documents with a name associated with the request.

9. The method of claim 1, wherein applying rules to the data extracted from the documents comprises examining a chain-of-title associated with the parcel.

10. The method of claim 1, wherein applying rules to the data extracted from the documents comprises examining mortgages relating to the parcel.

11. The method of claim 1, wherein applying rules to the data extracted from the documents comprises examining encumbrances relating to the parcel.

12. The method of claim 1, wherein the request includes a selection from the group consisting of the documents, identifiers of the documents, and images of the documents.

13. The method of claim 1, wherein extracting data from documents related to the parcel occurs prior in time to receiving a request to examine title to a specific parcel.

14. A title examination system, comprising:
means for receiving a title examination request, wherein the request comprises at least an identifier of a parcel;
automated means for extracting data from documents related to the request;
a processor responsive to the request; and
software that programs the processor to:
assemble output by applying rules to the data extracted from the documents; and
export the output to an external computer.

15. The title examination system of claim 14, further comprising a property records database, wherein the software further programs the processor to:
use the identifier of the parcel to search the property records database to identify the documents related to the title to the parcel, thereby generating search linkages for each identified document; and
identify relationships among the documents.

16. The title examination system of claim 15, wherein in programming the processor to assemble output by applying rules to the data extracted from the documents,, the software programs the processor to apply the rules to the search linkages, the relationships among the documents, and the data extracted from the documents.

17. The title examination system of claim 14, wherein in programming the processor to assemble output by applying rules to the data extracted from the documents, the software programs the processor to:
select a template relating to a rule, wherein the template includes a conditional expression;
evaluate the conditional expression;
based on the evaluation of the conditional expression, select data elements from the data extracted from the documents for inclusion in the template; and
include the template as part of the output.

18. The title examination system of claim 14, wherein in programming the processor to assemble output by applying rules to the data extracted from the documents, the software programs the processor to:
select a template relating to a rule, wherein the template includes a conditional expression;
evaluate the conditional expression;
based on the evaluation of the conditional expression, generate an item for an exceptions file;
for each item in the exceptions file, select data for transmission to a user computer;
receive a response from a user;
based on the response, select data elements from the data associated with the documents for inclusion in the template; and
include the template as part of the output.

19. The title examination system of claim 14, wherein the output comprises a selection from the group consisting of purchase title policy, refinance title policy, prelim, title information report, abstract, purchase title commitment, refinance title commitment, document, data stream, XML elements, and electronic transmission.

20. The title examination system of claim 14, wherein in programming the processor to apply rules to the data extracted from the documents the software programs the processor to compare a name on one or more documents with a name on one or more other documents.

21. The title examination system of claim 14, wherein in programming the processor to apply rules to the data extracted from the documents the software programs the processor to compare a name on one or more documents with a name associated with the request.

22. The title examination system of claim 14, wherein in programming the processor to apply rules to the data extracted from the documents the software programs the processor to examine a chain-of-title associated with the parcel.

23. The title examination system of claim 14, wherein in programming the processor to apply rules to the data extracted from the documents the software programs the processor to examine mortgages relating to the parcel.

24. The title examination system of claim 14, wherein in programming the processor to apply rules to the data extracted from the documents the software programs the processor to examine encumbrances relating to the parcel.

25. The title examination system of claim 14, wherein the request includes a selection from the group consisting of the documents, identifiers of the documents, and images of the documents.

26. A computer-readable medium having stored thereon:
code for programming a processor to receive a request to examine title to a specific parcel, wherein the request comprises at least an identifier of the parcel;
code for programming the processor to extract data from documents related to the parcel;
code for programming the processor to assemble output by applying rules to the data extracted from the documents; and
code for programming the processor to export the output to an external computer.

27. The computer-readable medium of claim 26, wherein the computer-readable medium has stored thereon:
code for programming the processor to use the identifier of the parcel to search a property records database to identify the documents related to the title to the parcel, thereby generate search linkages for each identified document; and
code for programming the processor to identify relationships among the documents.

28. The computer-readable medium of claim 27, wherein the computer-readable medium has stored thereon:
code for programming the processor to apply the rules to the search linkages, the relationships among the documents, and the data extracted from the documents.

29. The computer-readable medium of claim 27, wherein the computer-readable medium has stored thereon:
code for programming the processor to select a template relating to a rule, wherein the template includes a conditional expression;
code for programming the processor to evaluate the conditional expression;
code for programming the processor to select data elements from the data extracted from the documents for inclusion in the template; and
code for programming the processor to include the template as part of the output.

30. The computer-readable medium of claim 27, wherein the computer-readable medium has stored thereon:
code for programming the processor to select a template relating to a rule, wherein the template includes a conditional expression;
code for programming the processor to evaluate the conditional expression;
code for programming the processor to generate an item for an exceptions file;
code for programming the processor to select data for transmission to a user computer;
code for programming the processor to receive a response from a user;
code for programming the processor to select data elements from the data associated with the documents for inclusion in the template; and
code for programming the processor to include the template as part of the output document.

31. A title examination system, comprising:
an interface to an external computer, wherein the interface is configured to receive a title examination request that includes at least an identifier of a parcel;
a data extraction arrangement configured to extract data from documents related to the request;
an output generation system configured to assemble output by applying rules to the data extracted from the documents; and
an interface configured to export the output to an external computer.

32. The title examination system of claim 31, further comprising a property records database, wherein the output generation system is further configured to:
use the identifier of the parcel to search the property records database to identify the documents related to the title to the parcel, thereby generating search linkages for each identified document; and
identify relationships among the documents.

33. The title examination system of claim 32, wherein the output generation system is further configured to apply the rules to the search linkages, the relationships among the documents, and the data extracted from the documents.

34. The title examination system of claim 32, wherein the output generation system is further configured to:
select a template relating to a rule, wherein the template includes a conditional expression;
evaluate the conditional expression;
based on the evaluation of the conditional expression, select data elements from the data extracted from the documents for inclusion in the template; and
include the template as part of the output.

35. The title examination system of claim 32, wherein the output generation system is further configured to:
select a template relating to a rule, wherein the template includes a conditional expression;
evaluate the conditional expression;
based on the evaluation of the conditional expression, generate an item for an exceptions file;
for each item in the exceptions file, select data for transmission to a user computer;
receive a response from a user;
based on the response, select data elements from the data associated with the documents for inclusion in the template; and
include the template as part of the output.

36. The title examination system of claim 32, wherein the output comprises a selection from the group consisting of purchase title policy, refinance title policy, prelim, title information report, abstract, purchase title commitment, refinance title commitment, document, data stream, XML elements, and electronic transmission.

37. The title examination system of claim 32, wherein the output generation system is further configured to compare a name on one or more documents with a name on one or more other documents.

38. The title examination system of claim 32, wherein the output generation system is further configured to compare a name on one or more documents with a name associated with the request.

39. The title examination system of claim 32, wherein the output generation system is further configured to examine a chain-of-title associated with the parcel.

40. The title examination system of claim 32, wherein the output generation system is further configured to examine mortgages relating to the parcel.

41. The title examination system of claim 32, wherein the output generation system is further configured to examine encumbrances relating to the parcel.

42. The title examination system of claim 32, wherein the request includes a selection from the group consisting of the documents, identifiers of the documents, and images of the documents.
